(19) United States
(12) Patent Application Publication
(10) Pub. No.: US 2014/0379981 A1
(43) Pub. Date: Dec. 25, 2014

(54) APPLICATION DISCOVERY USING STORAGE SYSTEM SIGNATURES

(71) Applicant: International Business Machines Corporation, Armonk, NY (US)

(72) Inventors: Hari H. Krishna, Hyderabad (IN); Arun Ramakrishnan, Chennai (IN); Rohit Shetty, Bangalore (IN)

(21) Appl. No.: 13/923,705

(22) Filed: Jun. 21, 2013

(51) Int. Cl. G06F 3/06

(52) U.S. Cl. CPC G06F 3/067; G06F 3/0619; G06F 3/0665
USPC 711/114

(57) ABSTRACT

Exemplary embodiments of the present invention disclose a method and system for identifying one or more applications stored on a storage system that is shared by one or more computer systems. In a step, an exemplary embodiment accesses the storage system. In another step, an exemplary accesses one or more file tables associated with the storage system. In another step, an exemplary embodiment analyzes the one or more file tables and one or more files on the storage system that are associated with the one or more applications to identify the one or more applications. In another step, an exemplary embodiment analyzes the one or more file tables and the one or more files to identify a respective dependency of the one or more applications.

### FIELD OF THE INVENTION

The present invention relates generally to application discovery in large computer systems and more specifically to automated application and application dependence discovery using information available on devices that store the applications.

### BACKGROUND

The administration of large computer systems to enhance their performance involves exploiting knowledge of the relationships between applications that execute on the systems and the software and hardware resources that the applications use during their execution. Knowledge of these relationships is necessary to enhance information flow and the efficient use of resources in the system. The process of identifying these relationships is called discovery and includes the identification of the applications that execute on a system their dependencies on each other and on physical and software resources in the system, and their physical and logical locations relative to the resources they access and use. Discovery is difficult in a large system because resources, dependencies, locations, and connections between system components are constantly changing because a system is often being augmented, modified, and updated with hardware and software.

Discovery is difficult to perform manually because a configuration of a large system may be extremely complex and may be altered frequently. Therefore automated discovery techniques are highly advantageous. One approach to automated discovery employs the execution of software to monitor applications on a system in real time while logging their interactions with other software and with hardware. While this approach may accomplish discovery, a consequence is that it may interfere with the operation of a system and consume valuable system resources, for example, CPU time, slowing the system down. Discovery in large enterprises often requires system authorizations and credentials to access individual systems to identify applications by executing discovery code on each system to monitor the system. Each individual system must be configured to execute the discovery code in this approach, which is a disadvantage. Automated discovery methods that do not interfere with executing applications or system performance and do not require a special system configuration are actively sought.

### SUMMARY

Exemplary embodiments of the present invention disclose a method and system for identifying one or more applications stored on a storage system that is shared by one or more computer systems. In a step, an exemplary embodiment accesses the storage system. In another step, an exemplary embodiment accesses one or more file tables associated with the storage system. In another step, an exemplary embodiment analyzes the one or more file tables and one or more files on the storage system that are associated with the one or more applications to identify the one or more applications. In another step, an exemplary embodiment analyzes the one or more file tables and the one or more files to identify a respective dependency of the one or more applications.

### BRIEF DESCRIPTION OF THE SEVERAL VIEWS OF THE DRAWINGS

FIG. 1 is a block diagram of a computer complex and illustrates an operation of an application discovery using storage system signatures, in accordance with an embodiment of the present invention.

FIG. 2 is a flow chart of an operation of a discovery manager, in accordance with an embodiment of the present invention.

FIG. 3 depicts a block diagram of components of a computing device, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

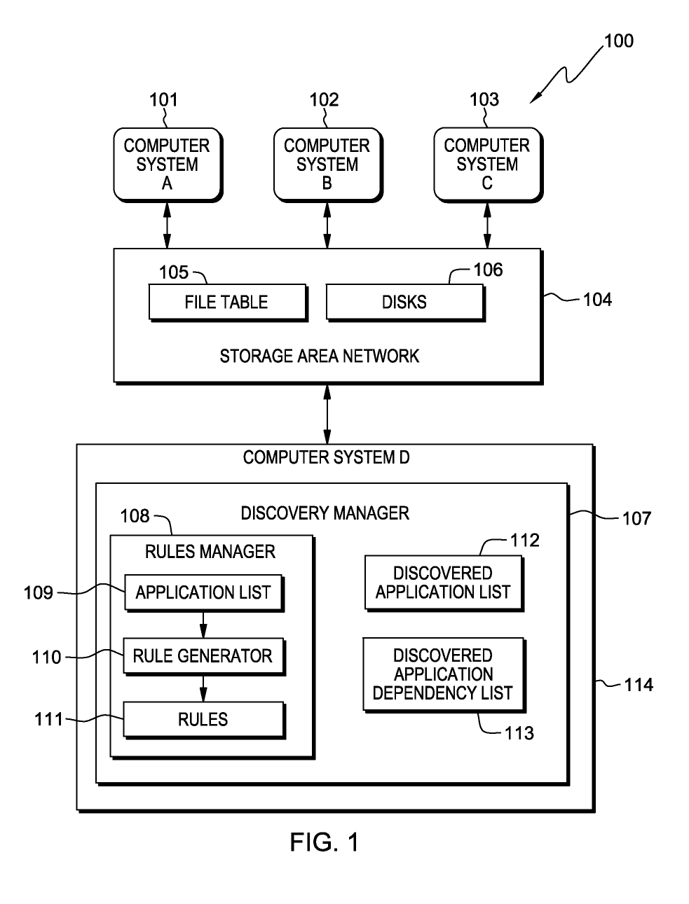

FIG. 1 depicts computer complex 100 that includes computer system 101, computer system 102, computer system 103, computer system 114, and storage area network 104, in accordance with an embodiment of the present invention. Computer systems 101, 102, 103 and 114 are attached to storage area network 104, which in one embodiment is a cloud storage solution. Discovery manager 107 in computer system 114 has access to storage area network 104 and performs a discovery function that includes searching for applications and dependencies between applications that are installed on storage area network 104 and that execute on computer systems 101, 102, and/or 103. Discovery manager 107 maintains application list 109 that includes one or more patterns of bits called signatures for each application to be searched for in file table 105 and/or disks 106 in storage area network 104. File table 105 contains information about a content of disks 106 that includes a name of a file on disk 106, a location of the file, and a name of a system that owns the file. Rule generator 110 analyzes application list 109 and generates rules 111 that are used by discovery manager 107 in a search of storage area network 104 for an application that is on application list 109. When an application on application list 109 is discovered on storage area network 104, a name of the application is placed on discovered application list 112. When a dependency of an application on application list 109 on another application on application list 109 is discovered on storage area network 104, a description of the dependency is placed on discovered application dependency list 113.

Application list 109 includes application1. Rule generator 110 generates one or more rules to detect application1 on storage area network 104 and a dependency that application1 may have on another application installed on storage area network 104 and inserts the one or more rules into rules 111. Rule generator 110 contains information about application1 that includes a name of application1 and a plurality of locations where application1 may be found in storage area network 104. Rule generator 110 also contains an information about a known dependency that application1 has on an application2 that may run on computer systems 101, 102, and 103. The information about a dependency that application1 has on application2 includes a name of application2 and a plurality of common installation locations of application2 on storage area network 104. Information in rule generator 110 on an application or on a dependency of the application is generated from at least one of a manual entry by a sentient entity and a computer generated entry from a published list. Rule generator 110 also accesses and uses information in discovered application list 112 and discovered application dependency list 113 to generate a rule that rule generator 110 inserts into rules 111. A rule in rules 111 may include one or more regular expressions. A regular expression is often used in computer programming and is a concise means to recognize particular strings of text and to search for and manipulate a string of text based on a character pattern in the text that matches a search pattern expressed in the regular expression.

Discovery manager 107 can perform a search using a regular expression on file table 105 and disks 106 to discover an application in application list 109 that is installed on computer systems 101, 102, and 103 and a dependency of the application on another application that is installed on computer systems 101, 102, and 103. Generally, in one embodiment discovery manager 107 can scan files available and accessed by different systems (e.g., computer systems 101, 102, and 103) using file patterns and rules to discover application and system discovery. For example, discovery manager 107 can run an adapter that connects to storage area network 104 through a file system (e.g., GPFS, etc.) and analyzes the information to provide OS, application and dependency information. As such, discovery manager 107 can discover applications and dependencies while computer systems 101, 102, and 103 are offline, but while storage area network 104 is online. Further, discovery manager 107 can discover applications and dependencies using bandwidth between itself and storage area network 104, but while not consuming bandwidth otherwise available to computer systems 101, 102, and 103. Further still, discovery manager 107 can discover applications and dependencies using a single set of login credentials for storage area network 104, and as such discovery manager 107 does not require login credentials for computer systems 101, 102, and 103.

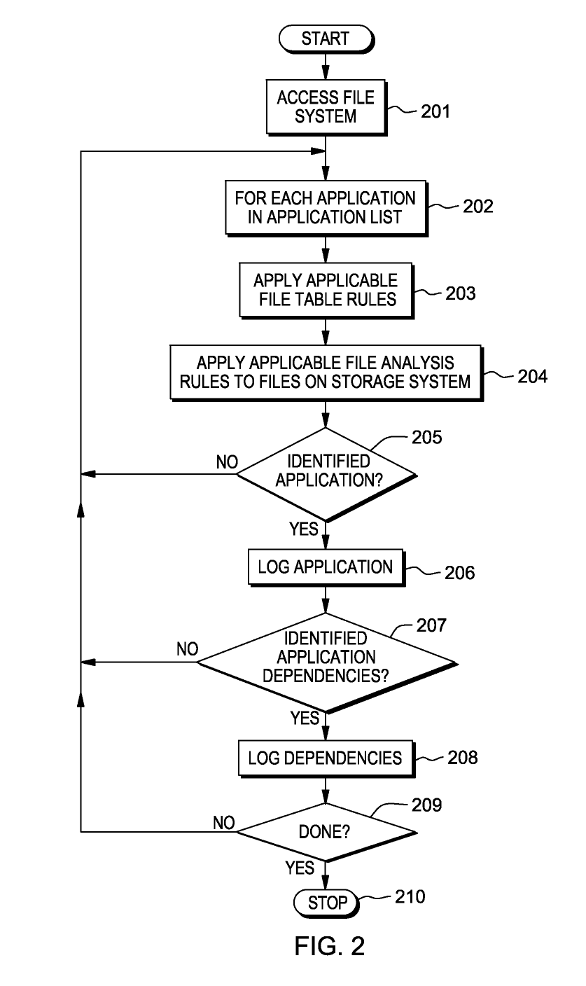

FIG. 2 depicts a flowchart of a process followed by discovery manager 107 in an application discovery process. In step 201 discovery manager 107 accesses storage area network 104 and in step 202 discovery manager 107 accesses application list 109 for a name of an application to be searched for in storage area network 104 on computer complex 100. In step 203 discovery manager 107 accesses and applies one or more rules in rules 111 to file table 105 in a search for a location and dependency information on the application. In step 204, discovery manager 107 applies one or more rules in rules 111 to disks 106 in a search for a identification and dependency information on the application. In decision step 205, if the application has not been identified on storage area network 104, discovery manager 107 begins a process again with another application on application list 109 in step 202. If the application has been identified, a name of the application is added to discovered application list 112 in step 206. In decision step 207, discovery manager 107 attempts to discover dependencies of the application on other applications in application list 109. If no dependencies are discovered, discovery manager 107 begins a process again with another application on application list 109 in step 202. If one or more dependencies are discovered in step 207, the one or more dependencies are added to discovered application dependency list 113 in step 208. In decision step 209, discovery manager 107 decides if all the applications in application list 109 have been searched for. If all the applications in application list 109 have been searched for, discovery manager 107 terminates a discovery process in step 210. Otherwise discovery manager 107 begins a process with another application on application list 109 in step 202.

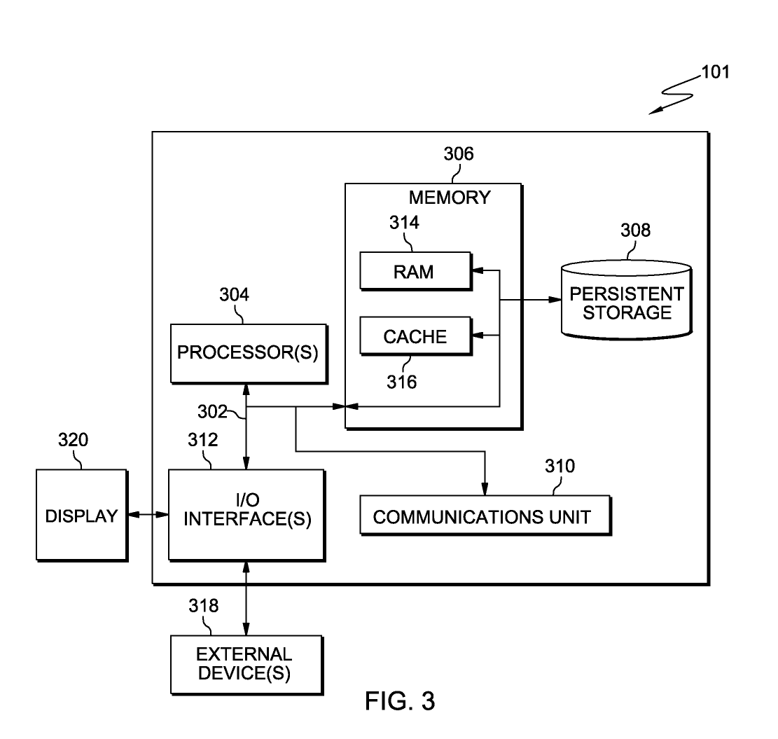

FIG. 3 depicts a block diagram of components of computer system 101 in accordance with an illustrative embodiment of the present invention which is representative. Computer systems 102, 103 and 114 have the same block diagram as computer system 101. It should be appreciated that FIG. 3 provides only an illustration of one implementation and does not imply any limitations with regard to the environments in which different embodiments may be implemented. Many modifications to the depicted environment may be made.

Computer system 101 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Discovery manager 107 is stored in persistent storage 308 for execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of computer system 101. In these examples, communications unit 310 includes one or more network interface cards. Communications unit 310 may provide communications through the use of either or both physical and wireless communications links. Discovery manager 107 may be downloaded to persistent storage 308 through communications unit 310.

I/O interface(s) 312 allows for input and output of data with other devices that may be connected to computer system 101. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., discovery manager 107 can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for identifying one or more applications stored on a storage system that is shared by one or more computer systems and for identifying a respective dependency of the one or more applications, the method composed of:
accessing the storage system;
accessing one or more file tables associated with the storage system;
analyzing the one or more file tables and one or more files on the storage system that are associated with the one or more applications to identify the one or more applications; and
analyzing the one or more file tables and the one or more files to identify the respective dependency of the one or more applications.

2. The method of claim 1 wherein:
the storage system is a storage area network (SAN).

3. The method of claim 1 further comprising a step:
specifying one or more bit patterns that are a signature of an application to be identified on the storage system in an application list.

4. The method of claim 1 wherein:
the analysis of the one or more file tables and the one or more files is accomplished with an application of one or more rules to the one or more file tables and the one or more files.

5. The method of claim 4 wherein:
the one or more rules include regular expressions.

6. The method of claim 4 wherein:
the one or more rules are applied on a result of the application of one or more rules.

7. The method of claim 1 wherein:
the respective dependency that is identified is between applications that are identified.

8. A computer system to identify one or more applications stored on a storage system that is shared by one or more computer systems and to identify a respective dependency of the one or more applications, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to access the storage system;
program instructions to access one or more file tables associated with the storage system;
program instructions to analyze the one or more file tables and one or more files on the storage system that are associated with the one or more applications to identify the one or more applications; and
program instructions to analyze the one or more file tables and the one or more files to identify the respective dependency of the one or more applications.

9. The computer system of claim 8 wherein:
the storage system is a storage area network (SAN).

10. The computer system of claim 8 further comprising:
program instructions to specify one or more bit patterns that are a signature of an application to be identified on the storage system in an application list.

11. The computer system of claim 8 wherein:
the analysis of the one or more file tables and the one or more files is accomplished with an application of one or more rules to the one or more file tables and the one or more files.

12. The computer system of claim 11 wherein:
the one or more rules include regular expressions.

13. The computer system of claim 11 wherein:
the one or more rules are applied on a result of the application of one or more rules.

14. The computer system of claim 8 wherein:
the respective dependency that is identified is between applications that are identified.

15. A computer program product to identify one or more applications stored on a storage system that is shared by one or more computer systems and to identify a respective dependency of the one or more applications, the computer program product comprising:
one or more computer-readable storage devices and program instructions stored on at least one of the one or more tangible storage devices, the program instructions comprising:
program instructions to access the storage system;
program instructions to access one or more file tables associated with the storage system;
program instructions to analyze the one or more file tables and one or more files on the storage system that are associated with the one or more applications to identify the one or more applications; and
program instructions to analyze the one or more file tables and the one or more files to identify the respective dependency of the one or more applications.

16. The computer program product of claim 15 wherein:
the storage system is a storage area network (SAN).

17. The computer program product of claim 15 further comprising:
program instructions to specify one or more bit patterns that are a signature of an application to be identified on the storage system in an application list.

18. The computer program product of claim 15 wherein:
the analysis of the one or more file tables and the one or more files is accomplished with an application of one or more rules to the one or more file tables and the one or more files.

19. The computer program product of claim 18 wherein:
the one or more rules include regular expressions.

20. The computer program product of claim 18 wherein:
the one or more rules are applied on a result of the application of one or more rules.
